(19) United States
(12) Patent Application Publication
(10) Pub. No.: US 2024/0278377 A1
(43) Pub. Date: Aug. 22, 2024

(54) POWER TOOL SPEED CONTROL

(71) Applicant: MILWAUKEE ELECTRIC TOOL CORPORATION, Brookfield, WI (US)

(72) Inventor: Dominick S. Ropella, Wauwatosa, WI (US)

(21) Appl. No.: 18/582,886

(22) Filed: Feb. 21, 2024

Related U.S. Application Data
(60) Provisional application No. 63/486,067, filed on Feb. 21, 2023.

(51) Int. Cl. B24B 23/02; B25F 5/00; B25F 5/02

(52) U.S. Cl. CPC B24B 23/024; B25F 5/001; B25F 5/02

(57) ABSTRACT

A power tool including a housing, a battery pack interface, a user input, a speed control interface, and a controller. The battery pack interface is configured to receive a removable and rechargeable battery pack. The user input is configured to control driving of a motor when actuated by a user. The speed control interface includes a first interface portion and a second interface portion. The first interface portion includes a capacitive touch surface configured to generate a speed setting signal in response to detecting a touch of the user. The second interface portion includes a display that includes a plurality of indicators configured to indicate a speed setting of the power tool. The controller includes a memory and an electronic processor. The controller is configured to receive the speed setting signal, and control, in response to the actuation of the user input, the motor to the speed setting.

### RELATED APPLICATIONS

This application claims the benefit of U.S. Provisional Patent Application No. 63/486,067, filed Feb. 21, 2023, the entire content of which is hereby incorporated by reference.

### FIELD

Embodiments described herein relate to a speed control of a power tool.

### SUMMARY

Power tools described herein include a housing, a battery pack interface, a user input, a speed control interface, and a controller. The battery pack interface is positioned at an end of the housing. The battery pack interface is configured to receive a removable and rechargeable battery pack. The user input is configured to control driving of a motor when actuated by a user. The speed control interface includes a first interface portion and a second interface portion. The first interface portion includes a capacitive touch surface configured to generate a speed setting signal in response to detecting a touch of the user. The second interface portion includes a display that includes a plurality of indicators configured to indicate a speed setting of the power tool. The controller includes a memory and an electronic processor. The controller is configured to receive the speed setting signal, and control, in response to the actuation of the user input, the motor to the speed setting.

In some aspects, the first interface portion includes a speed increase selector and a speed decrease selector.

In some aspects, the capacitive touch surface is configured to receive one or more multi-touch gestures.

In some aspects, the plurality of indicators includes one or more light emitting diodes.

In some aspects, the plurality of indicators includes an E-ink display.

In some aspects, the plurality of indicators are further configured to display an error code associated with a tool error.

In some aspects, the capacitive touch surface includes a capacitive touch slider configured to detect a sliding touch of the user, where, in response to detecting the sliding touch of the user in a first direction, the capacitive touch surface is configured to generate a speed increase setting signal, and where, in response to detecting the sliding touch of the user in a second direction, the capacitive touch surface is configured to generate a speed decrease setting signal.

In some aspects, the speed setting of the power tool includes a plurality of speed settings, and the first interface portion includes a plurality of capacitive touch surfaces, each of the plurality of capacitive touch surfaces includes a capacitive touch input element, and each of the capacitive touch input elements of the plurality of capacitive touch surfaces corresponds to one of a plurality of speed settings.

Power tools described herein include a housing, a battery pack interface, a user input, a speed control interface, and a controller. The battery pack interface is positioned at an end of the housing. The battery pack interface is configured to receive a removable and rechargeable battery pack. The user input is configured to control driving of a motor when actuated by a user. The speed control interface is configured to generate a speed setting signal including a speed setting from among a plurality of speed settings. The speed control interface includes a speed increase selector configured to increase a speed selection of the speed setting from among the plurality of speed settings, a speed decrease selector configured to decrease the speed selection of the speed setting from among the plurality of speed settings, and a plurality of indicators configured to indicate the speed setting selected from among the plurality of speed settings. The controller includes a memory and an electronic processor. The controller is configured to receive the speed setting signal, and control, in response to the actuation of the user input, the motor to the speed setting.

In some aspects, the speed increase selector and the speed decrease selector each include a touch sensitive surface.

In some aspects, the plurality of indicators include one or more light emitting diodes.

In some aspects, the plurality of indicators include an E-ink display.

In some aspects, the plurality of indicators are further configured to display an error code associated with a tool error.

Speed control systems described herein include a speed control interface configured to generate a speed setting signal including a speed setting from among a plurality of speed settings. The speed control interface is configured to increase a speed selection of the speed setting from among the plurality of speed settings and decrease the speed selection of the speed setting from among the plurality of speed settings. The speed control systems also include a plurality of indicators configured to indicate the speed setting selected from among the plurality of speed settings, and a circuit board including a memory and an electronic processor. The electronic processor is configured to receive the speed setting signal including the speed setting from among a plurality of speed settings, and control, in response to an actuation of a user input, a motor of the power tool to the speed setting.

In some aspects, the plurality of indicators include one or more light emitting diodes.

In some aspects, the plurality of indicators include an E-ink display.

In some aspects, the a plurality of indicators are further configured to display an error code associated with a tool error.

In some aspects, the speed control interface includes a speed increase selector and a speed decrease selector, the speed increase selector includes a first capacitive touch element configured to detect a sliding touch of the user, the speed decrease selector includes a second capacitive touch element configured to detect the sliding touch of the user, and, in response to detecting the sliding touch of the user in a first direction, the speed increase selector is configured to generate a speed increase setting signal, and in response to detecting the sliding touch of the user in a second direction, the speed decrease selector is configured to generate a speed decrease setting signal.

In some aspects, the speed control interface includes an first inductive sensor configured to detect a touch of a user in a first direction and the touch of the user in a second direction, the electronic processor is configured to increase the speed selection of the speed setting from among the plurality of speed settings in response to the inductive sensor detecting the touch of the user in the first direction, and the electronic processor is configured to decrease the speed selection of the speed setting from among the plurality of speed settings in response to the inductive sensor detecting the touch of the user in the second direction.

In some aspects, the speed increase selector and the speed decrease selector are mechanical buttons.

Power tools described herein include a housing, a battery pack interface, a user input, a speed control interface, and a controller. The battery pack interface is positioned at an end of the housing. The battery pack interface is configured to receive a removable and rechargeable battery pack. The user input is configured to control driving of a motor when actuated by a user. The speed control interface is configured to generate a speed setting signal including a speed setting from among a plurality of speed settings. The speed control interface includes a speed increase selector configured to increase a speed selection of the speed setting from among the plurality of speed selections, and a speed decrease selector configured to decrease the speed selection of the speed setting from among the plurality of speed selections. The controller includes a memory and an electronic processor. The controller is configured to receive the speed setting signal, and control, in response to the actuation of the user input, the motor to the speed setting.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1A illustrates a power tool, according to some embodiments.

FIG. 1B illustrates a side section view of the power tool of FIG. 1A, according to some embodiments.

FIG. 2 illustrates a block diagram of a control system of the power tool of FIGS. 1A-1B, according to some embodiments.

FIG. 3 illustrates a battery pack for use with the power tool of FIGS. 1A-1B, according to some embodiments.

FIG. 4 illustrates a block diagram of a control system of the battery pack of FIG. 3, according to some embodiments.

FIG. 5 illustrates a speed control interface for the power tool of FIGS. 1A-1B, according to some embodiments.

FIG. 6 illustrates a speed control interface for the power tool of FIGS. 1A-1B, according to some embodiments.

FIG. 7 illustrates a speed control interface for the power tool of FIGS. 1A-1B, according to some embodiments.

FIG. 8 illustrates a speed control interface for the power tool of FIGS. 1A-1B, according to some embodiments.

FIG. 9 illustrates a speed control interface for the power tool of FIGS. 1A-1B, according to some embodiments.

FIG. 10A illustrates a speed control interface for the power tool of FIGS. 1A-1B, according to some embodiments.

FIG. 10B illustrates a speed control interface for the power tool of FIGS. 1A-1B, according to some embodiments.

FIG. 11 illustrates a speed control interface for the power tool of FIGS. 1A-1B, according to some embodiments.

FIG. 12 illustrates a speed control interface for the power tool of FIGS. 1A-1B, according to some embodiments.

FIG. 13 illustrates a speed control interface for the power tool of FIGS. 1A-1B, according to some embodiments.

FIG. 14 illustrates a speed control interface for the power tool of FIGS. 1A-1B, according to some embodiments.

FIG. 15 illustrates a speed control interface for the power tool of FIGS. 1A-1B, according to some embodiments.

FIG. 16 illustrates a speed control interface for the power tool of FIGS. 1A-1B, according to some embodiments.

FIG. 17 illustrates a speed control interface for the power tool of FIGS. 1A-1B, according to some embodiments.

FIG. 18 illustrates a power tool including a speed control interface, according to some embodiments.

FIG. 19 illustrates a power tool including a speed control interface, according to some embodiments.

FIG. 20 illustrates a power tool including a speed control interface, according to some embodiments.

FIG. 21 illustrates a power tool including a speed control interface, according to some embodiments.

FIG. 22 illustrates a power tool including a speed control interface, according to some embodiments.

### DETAILED DESCRIPTION

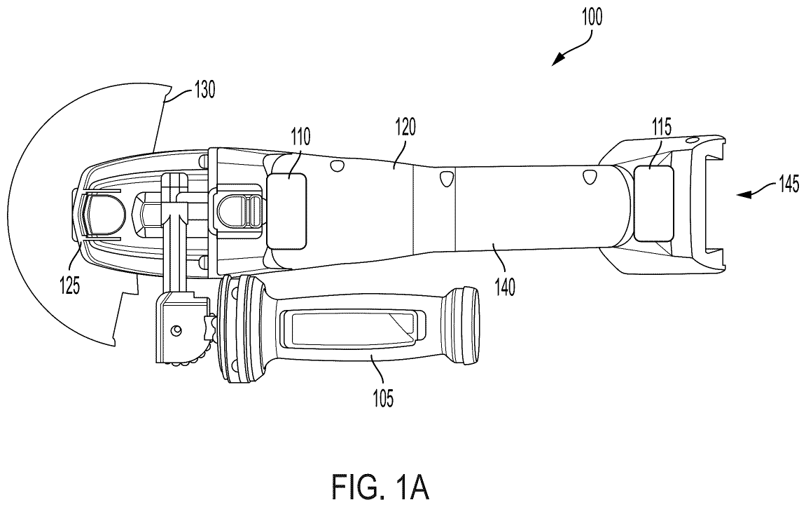

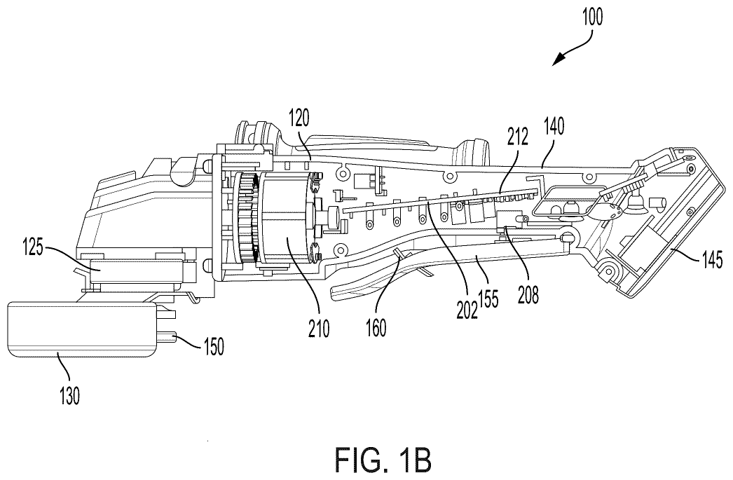

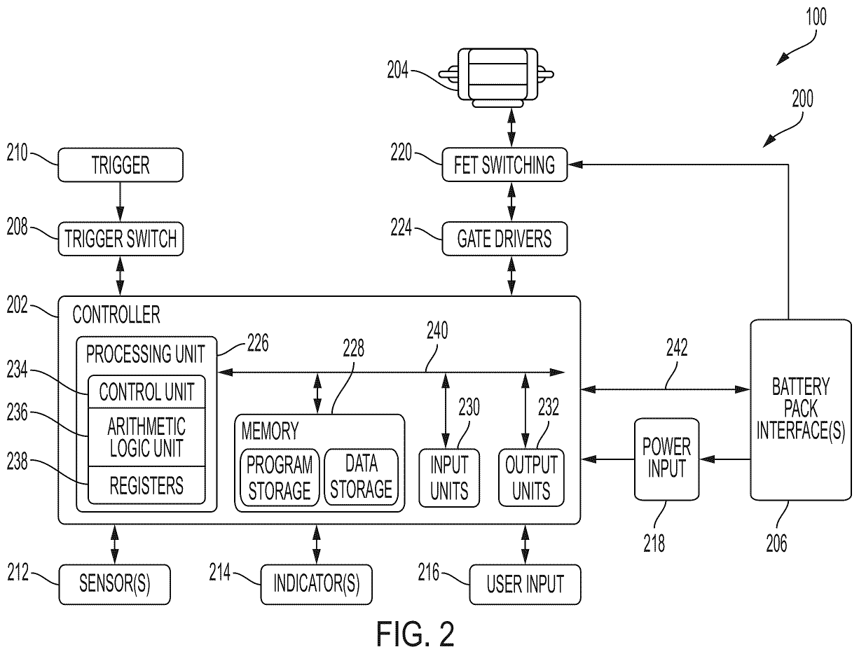

FIG. 1A illustrates a power tool 100, such as a portable rotary power tool, that implements several different methods and systems to control the tool and a motor of the tool. In some embodiments, the power tool 100 is a grinder or another type of power tool that includes speed control. The power tool 100 may include a main tool housing 120, a first handle 140 that extends along the main tool housing 120, and a second handle 105 that extends transversely in an outward direction from the main tool housing 120. A motor 210 (shown in FIG. 2) is located within the main tool housing 120. An output shaft 125 is coupleable to a tool holder that may be configured to receive an accessory 150, such as a cutting tool, a grinding disc, a rotary burr, a sanding disc, etc. Various types of accessories may be interchangeably attached to the tool holder and may be designed with different characteristics to perform different types of operations. For example, the accessory 150 may be made of a material and have dimensions suitable for performing a specific type of task. The characteristics of an accessory may affect the performance of the power tool 100 or may impose constraints on operation of the tool. For example, different accessory types may be configured to work at different rotational speeds or applied torques depending on the characteristics of the accessory and the task to be performed. During operation of the power tool 100, the motor and the output shaft 125 may be controlled to rotate at a wide range of speeds. The power tool 100 includes a first user interface portion 110 and a second user interface portion 115. One or both of the first user interface portion 110 and the second user interface portion 115 can be used to control and/or provide feedback related to the operation of the power tool 100. For example, the first user interface portion 110 can include a display or indicator(s) used to provide an indication of a set operating speed for the power tool 100. The second user interface portion 115 can include one or more user inputs for selecting or setting the set operating speed for the power tool 100. In some embodiments, one or both of the first user interface portion 110 and the second user interface portion include both the display or indicators and the one or more user inputs for setting and displaying the set operating speed for the power tool 100. In some embodiments, the power tool 100 includes only one of the first user interface portion or the second user interface portion.

Due to the wide range of speeds, in some embodiments, the power tool 100 may include a guard 130 to protect a user or another object in the surrounding environment from the different accessory types that may be attached to the tool holder. In some embodiments, the guard 130 prevents a user from contacting the accessory 150. In some embodiments, the guard 130 provides protection against, for example, sparks.

In some embodiments, the first handle 140 may define a battery pack receptacle 145, which is positioned on an end of the first handle 140 opposite the main tool housing 120. The battery pack receptacle 145 (also referred to as a battery pack interface) is configured to selectively, mechanically and electrically connect to a rechargeable battery pack (i.e., a power supply) for powering the motor 210. The battery pack is insertable into or attachable to the battery pack receptacle 145. The battery pack may include any of a number of different nominal voltages (e.g., 12V, 18V, 24V, 36V, 40V, 48V, etc.), and may be configured having any of a number of different chemistries (e.g., lithium-ion, nickel-cadmium, etc.). In some embodiments, the motor 210 may be powered by a remote power source (e.g., an AC electrical outlet) through a power cord and a power interface of the power tool 100. The first handle 140 can further contain control electronics for the power tool 100.

FIG. 1B illustrates a side section view of the power tool 100. In some embodiments, a controller 202 (e.g., located on a printed circuit board) is located within the first handle 140. In some embodiments, sensors 212 may also be located within the first handle 140. The output shaft 125 protrudes downwards, towards a potential workpiece. In some embodiments, the accessory 150 (e.g., a grinder blade) may be attached to the output shaft 125. Because an accessory 150, such as a grinder blade, is potentially hazardous to the user and the area surrounding the power tool 100, the guard 130 is also attached to the output shaft 125 and protrudes downward towards a workpiece and extends around the blade 150. This provides protection from the blade 150 and any potential debris that is produced during operation.

In some embodiments, the motor 210 is located between the output shaft 125 and the battery pack receptacle 145, and beneath a user input or a trigger 155 within the main tool housing 120. The trigger 155 is used to control the motor 210, which receives control signals from the controller 202 to control the output shaft 125 and other aspects of the power tool 100.

The first handle 140 includes the switch or trigger 155 operable to electrically connect the power source (e.g., the battery pack) and the motor 210. In some embodiments, the trigger 155 may be a “lock-off” trigger having a paddle member and a lock-off member 160 supported by the paddle member. The paddle member is operable to actuate a trigger switch 208 electrically connected to the controller 202. The switch 208 is configured to control selective activation and deactivation of the motor 210 during operation of the power tool 100. The lock-off member 160 is configured to selectively prevent operation of the paddle member (e.g., prevent activation of the switch 208). In some embodiments, the paddle member acts as the detection for a user's first hand on the first handle 140. In other embodiments, a user's hand is detected using other sensors (e.g., grip sensors, pressure sensors, touch sensors, electromechanical sensors, etc.).

FIG. 2 illustrates a control system 200 (e.g., a speed control system) for the power tool 100. The control system 200 includes a controller 202. The controller 202 is electrically and/or communicatively connected to a variety of modules or components of the power tool 100. For example, the illustrated controller 202 is electrically connected to a motor 204, a battery pack interface 206, a trigger switch 208 (connected to a trigger), one or more sensors or sensing circuits 212, one or more indicators 214, a user input module 216, a power input module 218, an inverter bridge or FET switching module 220 (e.g., including a plurality of switching FETs), and gate drivers 224 for driving the FET switching module 220. In some embodiments, motor 204 is a permanent magnet motor. The controller 202 includes combinations of hardware and software that are operable to, among other things, control the operation of the power tool 100, monitor the operation of the power tool 100, activate the one or more indicators 214 (e.g., an LED), etc.

The controller 202 includes a plurality of electrical and electronic components that provide power, operational control, and protection to the components and modules within the controller 202 and/or the power tool 100. For example, the controller 202 includes, among other things, a processing unit 226 (e.g., a microprocessor, a microcontroller, an electronic controller, an electronic processor, or another suitable programmable device), a memory 228, input units 230, and output units 232. The processing unit 226 includes, among other things, a control unit 234, an arithmetic logic unit (“ALU”) 236, and a plurality of registers 238, and is implemented using a known computer architecture (e.g., a modified Harvard architecture, a von Neumann architecture, etc.). The processing unit 226, the memory 228, the input units 230, and the output units 232, as well as the various modules or circuits connected to the controller 202 are connected by one or more control and/or data buses (e.g., common bus 240). The control and/or data buses are shown generally in FIG. 2 for illustrative purposes. The use of one or more control and/or data buses for the interconnection between and communication among the various modules, circuits, and components would be known to a person skilled in the art in view of the invention described herein.

The memory 228 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 226 is connected to the memory 228 and executes software instructions that are capable of being stored in a RAM of the memory 228 (e.g., during execution), a ROM of the memory 228 (e.g., on a generally permanent basis), or another non-transitory computer readable medium such as another memory or a disc. Software included in the implementation of the power tool 100 can be stored in the memory 228 of the controller 202. The software includes, for example, firmware, one or more applications, program data, filters, rules, one or more program modules, and other executable instructions. The controller 202 is configured to retrieve from the memory 228 and execute, among other things, instructions related to the control processes and methods described herein. In other constructions, the controller 202 includes additional, fewer, or different components.

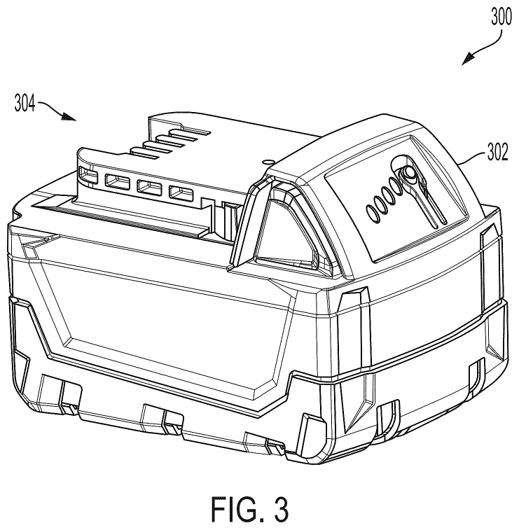

The battery pack interface 206 includes a combination of mechanical components (e.g., rails, grooves, latches, etc.) and electrical components (e.g., one or more terminals) configured to and operable for interfacing (e.g., mechanically, electrically, and communicatively connecting) with a battery pack. For example, power provided by a battery pack 300 (see FIG. 3) to the power tool 100 is provided through the battery pack interface 206 to the power input module 218. The power input module 218 includes combinations of active and passive components to regulate or control the power received from the battery pack 300 prior to power being provided to the controller 202. The battery pack interface 206 also supplies power to the FET switching module 220 to be switched by the switching FETs to selectively provide power to the motor 204. The battery pack interface 206 also includes, for example, a communication line 242 for providing a communication line or link between the controller 202 and the battery pack 300.

The sensors 212 include one or more current sensors, one or more speed sensors, one or more Hall effect sensors, one or more temperature sensors, etc. The indicators 214 include, for example, one or more light-emitting diodes (“LEDs”). The indicators 214 can be configured to display conditions of, or information associated with, the power tool 100. For example, the indicators 214 are configured to indicate measured electrical characteristics of the power tool 100, the status of the power tool, the status the motor 204, etc. The user input module 216 is operably coupled to the controller 202 to, for example, select a forward mode of operation or a reverse mode of operation, a torque and/or speed setting for the power tool 100 (e.g., using torque and/or speed switches), etc. In some embodiments, the user input module 216 includes a combination of digital and analog input or output devices required to achieve a desired level of operation for the power tool 100, such as one or more knobs, one or more dials, one or more switches, one or more buttons, etc.

FIG. 3 illustrates a battery pack 300. The battery pack 300 includes a housing 302 and an interface portion 304 for connecting the battery pack 300 to a power tool, such as the power tool 100.

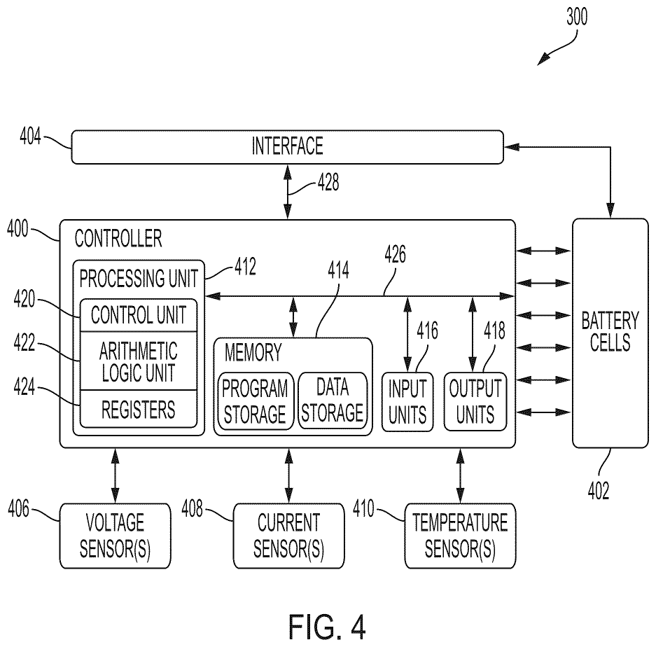

FIG. 4 illustrates a control system for the battery pack 300. The control system includes a controller 400. The controller 400 is electrically and/or communicatively connected to a variety of modules or components of the battery pack 300. For example, the illustrated controller 400 is connected to one or more battery cells 402 and an interface 404 (e.g., the interface portion 304 of the battery pack 300 illustrated in FIG. 3). The controller 400 is also connected to one or more voltage sensors or voltage sensing circuits 406, one or more current sensors or current sensing circuits 408, and one or more temperature sensors or temperature sensing circuits 410. The controller 400 includes combinations of hardware and software that are operable to, among other things, control the operation of the battery pack 300, monitor a condition of the battery pack 300, enable or disable charging of the battery pack 300, enable or disable discharging of the battery pack 300, etc.

The controller 400 includes a plurality of electrical and electronic components that provide power, operational control, and protection to the components and modules within the controller 400 and/or the battery pack 300. For example, the controller 400 includes, among other things, a processing unit 412 (e.g., a microprocessor, a microcontroller, an electronic processor, an electronic controller, or another suitable programmable device), a memory 414, input units 416, and output units 418. The processing unit 412 includes, among other things, a control unit 420, an ALU 422, and a plurality of registers 424, and is implemented using a known computer architecture (e.g., a modified Harvard architecture, a von Neumann architecture, etc.). The processing unit 412, the memory 414, the input units 416, and the output units 418, as well as the various modules or circuits connected to the controller 400 are connected by one or more control and/or data buses (e.g., common bus 426). The control and/or data buses are shown generally in FIG. 4 for illustrative purposes. The use of one or more control and/or data buses for the interconnection between and communication among the various modules, circuits, and components would be known to a person skilled in the art in view of the invention described herein.

The memory 414 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 412 is connected to the memory 414 and executes software instructions that are capable of being stored in a RAM of the memory 414 (e.g., during execution), a ROM of the memory 414 (e.g., on a generally permanent basis), or another non-transitory computer readable medium such as another memory or a disc. Software included in the implementation of the battery pack 300 can be stored in the memory 414 of the controller 400. The software includes, for example, firmware, one or more applications, program data, filters, rules, one or more program modules, and other executable instructions. The controller 400 is configured to retrieve from the memory 414 and execute, among other things, instructions related to the control processes and methods described herein. In other constructions, the controller 400 includes additional, fewer, or different components.

The interface 404 includes a combination of mechanical components (e.g., rails, grooves, latches, etc.) and electrical components (e.g., one or more terminals) configured to and operable for interfacing (e.g., mechanically, electrically, and communicatively connecting) the battery pack 300 with another device (e.g., a power tool, a battery pack charger, etc.). For example, the interface 404 is configured to communicatively connect to the controller 400 via a communications line 428.

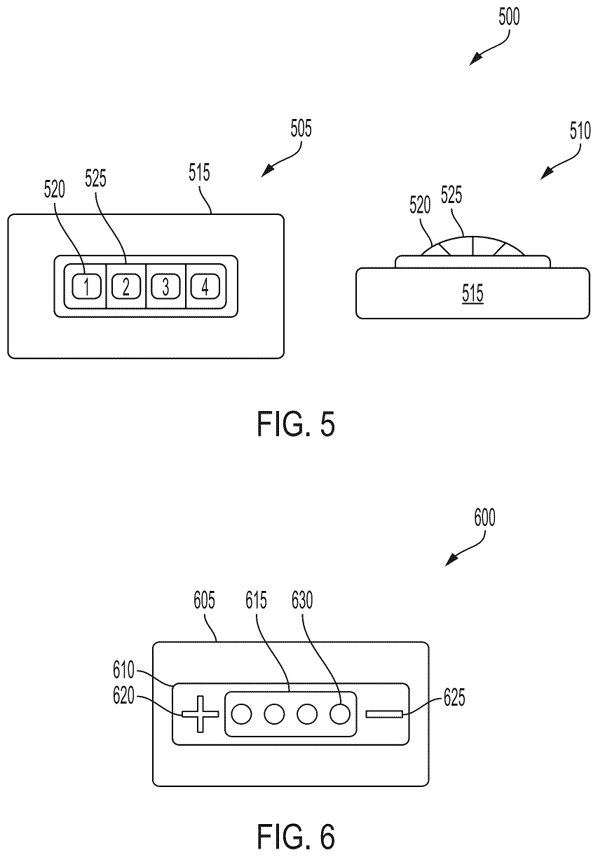

FIG. 5 illustrates a speed control interface 500 for the power tool 100, according to some embodiments. FIG. 5 includes two views of the speed control interface 500 (also referred to as a rotary dial), a forward-facing view 505 and a perspective view 510. The rotary dial 500 includes an interface housing 515 configured to attach to the power tool 100. In some embodiments, the interface housing 515 is integrally formed with the housing 120 of the power tool 100 (e.g., at the first user interface portion 110 and/or the second user interface portion 115). In other embodiments, the interface housing 515 is configured to be electrically and mechanically coupled to the housing 120 of the power tool 100 without being integrally formed. The rotary dial 500 includes a dial portion 520 configured to rotate around a central axis. The dial portion 520 includes a plurality of speed settings 525, with each one of the plurality of speed settings 525 having a number that corresponds with a set speed of the power tool 100. A user of the power tool 100 may select one of the plurality of speed settings 525 in order to set a maximum speed of operation of the power tool 100. Once the user has selected one of the speed settings, the controller 202 is configured to control the motor of the power tool 100 at that selected speed. In some embodiments, the speed control interface 500 is implemented on the same printed circuit board as the controller 202 or is electrically connected to the printed circuit board that includes the controller 202.

FIG. 6 illustrates a speed control interface 600 for the power tool 100, according to some embodiments. The speed control interface 600 includes an interface housing 605 and may be similarly configured to interface housing 515, as previously described. The speed control interface 600 includes a first interface portion 610 and a second interface portion 615. In some examples, the first interface portion 610 includes input selectors, such as a speed increase selector 620 and a speed decrease selector 625. The speed increase selector 620 is configured to incrementally increase a speed setting from among a plurality of speed settings of the power tool 100. Similarly, the speed decrease selector 625 is configured to incrementally decrease the speed setting of plurality of speed settings of the power tool 100. Once a speed setting is selected, the speed control interface 600 generates a signal including the speed control setting and sends the signal to the controller 202. The controller 202 then sets the speed of the motor 210 corresponding to the desired speed setting. In some embodiments, the speed control interface 600 is implemented on the same printed circuit board as the controller 202 or is electrically connected to the printed circuit board that includes the controller 202.

In some embodiments, the increase selector 620 and the speed decrease selector 625 are capacitive touch buttons. A capacitive touch button is a type of touch-sensitive interface that detects changes in capacitance caused by the user touching the surface. The increase selector 620 and the speed decrease selector 625 include a touch sensitive surface. For instance, when a user of the power tool 100 interacts with the increase selector 620 or the speed decrease selector 625, the touch-sensitive surface, a change in capacitance is caused that is measured by the controller 202, which then processes the data to determine the touch location and corresponding speed setting. The capacitive touch interface can offer an advantage over some other types of interfaces. For example, the capacitive touch interface is not subject to wear and tear, making it a more reliable and long-lasting option. Additionally, the touch-sensitive surface is easy to clean and maintain, ensuring that the interface remains functional even after heavy use. The capacitive touch interface also allows for more precise control over the speed of the power tool 100, as it is able to detect a wide range of touch inputs, including multi-touch gestures. In some embodiments, the increase selector 620 and speed decrease selector 625 are resistive touch buttons, inductive sensor buttons, mechanical buttons, or another type of selector switch.

The second interface portion 615 includes a plurality of indicators 630 configured to indicate the present speed selection from among the plurality of speed settings of the power tool 100. As a user interacts with either the increase selector 620 or speed decrease selector 625 the speed setting of the power tool 100 increases or decreases, and corresponding speed selection is represented by the plurality of indicators 630. In some embodiments, the plurality of indicators 630 is a strip of light emitting diodes (LEDs). In some embodiments, the plurality of indicators 630 is an LED strip, a light bar, or any other type of illuminating indicator. An individual one of the plurality of indicators 630 can be illuminated to illustrate a selected speed setting. Alternatively, multiple of the indicators 630 can be illuminated to illustrate a selected speed setting (e.g., three out of four indicators illuminated to show the third highest of four speed settings).

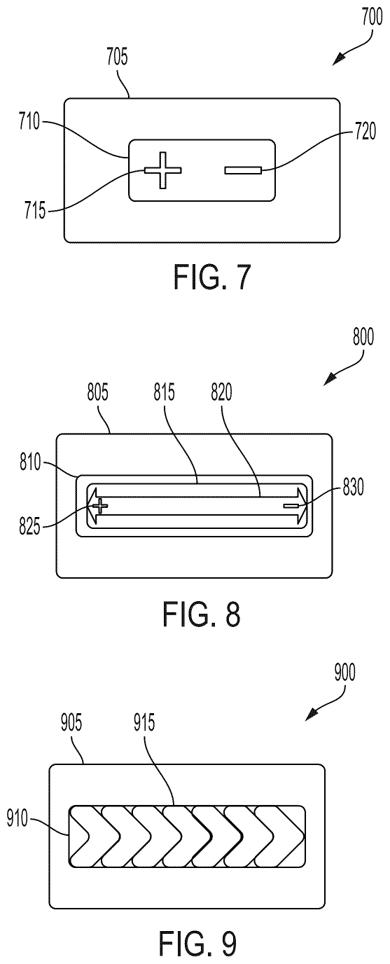

FIG. 7 illustrates a speed control interface 700 for the power tool 100, according to some embodiments. The speed control interface 700 includes an interface housing 705, similar to previously described interface housings. The speed control interface 700 further includes an interface portion 710, a speed increase selector 715, and a speed decrease selector 720. In the illustrated embodiment, the increase selector 715 and the speed decrease selector 720 are mechanical push buttons configured to select a speed setting of the power tool 100 from among a plurality of speed settings, as previously described. In other embodiments, the increase selector 715 and the speed decrease selector 720 are resistive touch buttons, inductive sensor buttons, capacitive sensors, or another type of selector switch. In some embodiments, the speed control interface 700 is implemented on the same printed circuit board as the controller 202 or is electrically connected to the printed circuit board that includes the controller 202.

FIG. 8 illustrates a speed control interface for the power tool 100, according to some embodiments. The speed control interface 800 includes an interface housing 805, similar to previously described interface housings. The interface housing 805 includes a capacitive interface portion 810. The capacitive interface portion 810 includes a capacitive touch slider 815. In some examples, the capacitive touch slider 815 includes a speed selection portion 820, the speed selection portion 820 including a speed increase indicator 825 and a speed decrease indicator 830. In some examples, the speed selection portion 820 is only a capacitive touch input. In other examples, the speed selection portion 820 also includes a display configured to indicate a present speed setting of the power tool 100. For instance, a user of the power tool 100 may drag their finger across the speed selection portion 820 to increase (e.g., to the left) or decrease (e.g., to the right) the speed setting of the power tool 100. In some embodiments, the speed selection portion 820 displays the speed setting of the power tool 100 as the user increases or decreases the select speed (e.g., using a plurality of LEDs). In some embodiments, the speed selection portion 820 continuously displays the speed setting of the power tool 100 (e.g., using any of the indication techniques described herein). In some embodiments, the speed control interface 800 is implemented on the same printed circuit board as the controller 202 or is electrically connected to the printed circuit board that includes the controller 202.

FIG. 9 illustrates a speed control interface for the power tool 100, according to some embodiments. The speed control interface 900 includes a circuit board 905 (e.g., the circuit board including controller 202) including a capacitive slider element 910. The capacitive slider element 910 includes a plurality of capacitive input elements 915. Each of the capacitive input elements 915 is configured to correspond with a speed setting from among a plurality of speed settings for the power tool 100. In some examples, the circuit board 905 is similar to the speed selection portion 820 as previously described. In some embodiments, the capacitive input elements also correspond to LEDs or another indicator that is illuminated as a capacitive input unit is selected (e.g., either the input elements 915 themselves or separate LEDs associated with the input elements 915). In some embodiments, the speed control interface 900 is implemented on the same printed circuit board as the controller 202 or is electrically connected to the printed circuit board that includes the controller 202.

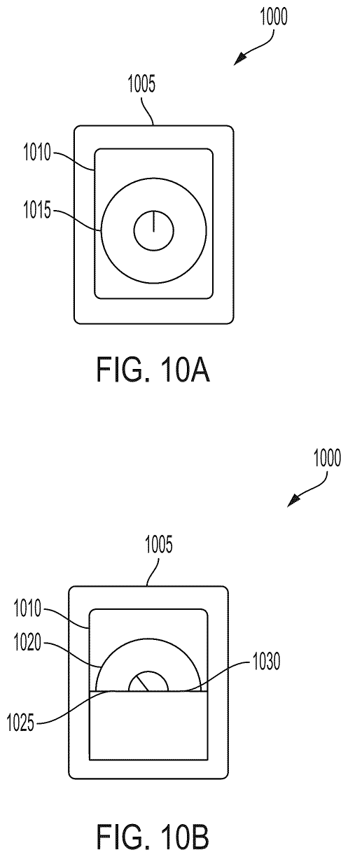

FIG. 10A and FIG. 10B illustrate a speed control interface 1000 for the power tool 100, according to some embodiments. The speed control interface 1000 includes a circuit board 1005 (e.g., the circuit board including controller 202) including an inductive sensor element 1010. The inductive sensor element 1010 has an inductive sensor dial 1015. In the embodiment illustrated in FIG. 10A, the inductive sensor dial 1015 is configured to increase a speed setting of the motor when a user drags their finger around the dial in a clockwise direction. The inductive sensor dial 1015 is configured to decrease the speed setting of the motor when a user drags their finger around the dial in a counter-clockwise direction. In some embodiments, the directions are reversed. For example, when the user drags their finger across the dial in a clockwise direction, the speed setting of the power tool 100 is increased to a maximum speed. Once the speed setting of the power tool 100 has reached a maximum setting, subsequent rotation in the clockwise direction does not change the speed setting. Likewise, when the user drags their finger across the dial in a counter-clockwise direction, the speed setting of the power tool 100 is decrease to a maximum speed. FIG. 10B includes an alternative embodiment of the speed control interface 1000, with an inductive sensor dial 1020 configured in a half-circle shape. At one of the inductive sensor dial 1020 is a minimum speed setting 1025 and at the other end is a maximum speed setting 1030. In this embodiment, when the user drags their finger across the dial towards the minimum speed setting 1025, the speed setting of the power tool 100 is decrease to a minimum speed. When the user drags their finger across the dial towards the maximum speed setting 1030, the speed setting of the power tool 100 is increased to a maximum speed. In some embodiments, the speed control interface 1000 is implemented on the same printed circuit board as the controller 202 or is electrically connected to the printed circuit board that includes the controller 202.

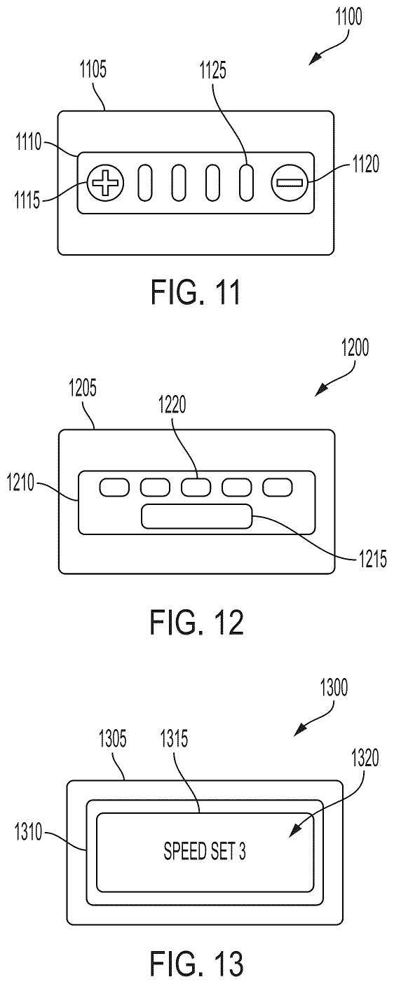

FIG. 11 illustrates a speed control interface 1100 for the power tool 100, according to some embodiments. The speed control interface 1100 includes an interface housing 1105 similar to the previously described interface housings. The speed control interface 1100 includes an interface portion 1110. In some examples, the interface portion 1110 includes input selectors, such as a speed increase selector 1115 and a speed decrease selector 1120. The speed increase selector 1115 is configured to incrementally increase a speed setting from among a plurality of speed settings of the power tool 100. Similarly, the speed decrease selector 1120 is configured to incrementally decrease the speed setting of plurality of speed settings of the power tool 100. In some examples, the speed increase selector 1115 and the speed decrease selector 1120 are capacitive touch buttons. Once a user has selected one of the speed settings from the plurality of speed settings, the speed control interface 1100 generates a speed setting signal and provides or transmits the speed setting signal to the controller 202. The controller 202 then sets the speed of the motor 210 in accordance with the selected speed. In some examples, the speed increase selector 1115 and speed decrease selector 1120 are resistive touch buttons, inductive sensor buttons, mechanical push buttons, or another type of selector switch. In some embodiments, the speed control interface 1100 is implemented on the same printed circuit board as the controller 202 or is electrically connected to the printed circuit board that includes the controller 202.

The interface portion 1110 includes a plurality of indicators 1125 configured to indicate the present speed selection from among the plurality of speed settings of the power tool 100. As a user interacts with either the increase selector 1115 or speed decrease selector 1120 the speed setting of the power tool 100 increases or decreases, and corresponding speed selection is represented by the plurality of indicators 1125. In some embodiments, the plurality of indicators 1125 is a strip of light emitting diodes (LEDs). In some embodiments, the plurality of indicators 1125 is an LED strip, a light bar, or any other type of illuminating indicator. An individual one of the plurality of indicators 1125 can be illuminated to illustrate a selected speed setting. Alternatively, multiple of the indicators 1125 can be illuminated to illustrate a selected speed setting (e.g., three out of four indicators illuminated to show the third highest of four speed settings).

FIG. 12 illustrates a speed control interface 1200 for the power tool 100, according to some embodiments. The speed control interface 1100 includes an interface housing 1205 and may be similar to previously described interface housings. The speed control interface 1200 includes an interface portion 1210. In some examples, the interface portion 1210 includes a single input selector, such as a button 1215. The button 1215 is configured to incrementally set a speed setting from among a plurality of speed settings of the power tool 100. In some examples, when a user presses the button 1215, the button 1215 provides or transmits a signal to the controller 202 of the power tool 100 to incrementally increase a speed setting from among the plurality of speed settings of the power tool 100. In some embodiments, the button 1215 is configured to incrementally decrease a speed setting from among the plurality of speed settings of the power tool 100. In some instances, the button 1215 has multiple operating modes. For instance, the button 1215 may be configured to have a short button press operation and a long button press operation. A short press of the button 1215 may incrementally increase a speed setting, while a long button press may incrementally decrease a speed setting. The interface portion 1210 includes a plurality of indicators 1220 configured to indicate the present speed selection from among the plurality of speed settings of the power tool 100. As a user interacts with the button 1215 and the speed setting of the power tool 100 increases or decreases, the corresponding speed selection is represented by the plurality of indicators 1220. The indicators 1220 may be configured as previously described LEDs, or as any other type of illuminating indicator. An individual one of the plurality of indicators 1220 can be illuminated to illustrate a selected speed setting. Alternatively, multiple of the indicators 1220 can be illuminated to illustrate a selected speed setting (e.g., three out of five indicators illuminated to show the third highest of five speed settings). In some embodiments, the speed control interface 1200 is implemented on the same printed circuit board as the controller 202 or is electrically connected to the printed circuit board that includes the controller 202.

FIG. 13 illustrates a speed control interface 1300 for the power tool 100, according to some embodiments. The speed control interface 1300 includes an interface housing 1305 and may be similar to previously described interface housings. The speed control interface 1300 includes an interface portion 1310 that includes an LCD display 1315. The LCD display 1315 is configured to display information about the speed settings of the power tool 100. For instance, when a user sets a first speed of the power tool 100, the LCD display 135 displays the set speed. The LCD display 135 may be configured to display other tool information, such as a motor revolutions per minute, torque settings, battery life, or the like. The display 1315 can also be used in conjunction with any of the speed selection inputs described herein. In some embodiments, the speed selection comes from a remote or external device (e.g., a mobile phone). In some embodiments, the speed control interface 1300 is implemented on the same printed circuit board as the controller 202 or is electrically connected to the printed circuit board that includes the controller 202.

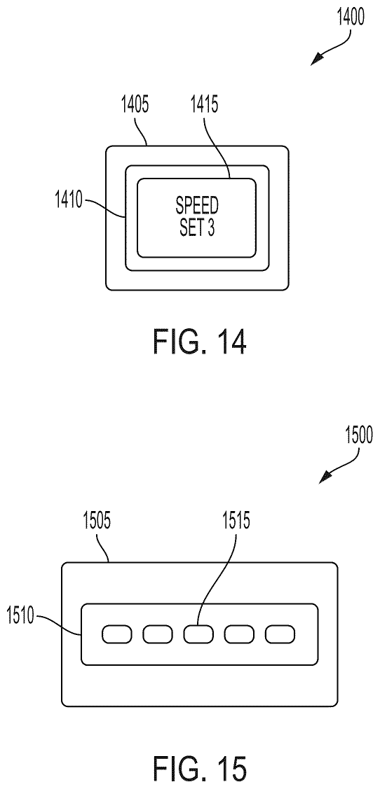

FIG. 14 illustrates a speed control interface 1400 for the power tool 100, according to some embodiments. The speed control interface 1400 includes an interface housing 1305 and may be similar to previously described interface housings. The speed control interface 1400 includes an interface portion 1410 that includes an E-ink display 1415. The E-ink display 1415 is configured to display information about the speed settings of the power tool 100, similar to previously described LCD display 1315. The speed control interface 1400 may include other forms of display, such as LED, organic LED (OLED), active matrix organic LED (AMOLED), thin film transistor LCD (TFT), quantum dot LED (QLED), or the like. In some embodiments, the speed control interface 1400 is implemented on the same printed circuit board as the controller 202 or is electrically connected to the printed circuit board that includes the controller 202.

FIG. 15 illustrates a speed control interface 1500 for the power tool 100, according to some embodiments. The speed control interface 1500 includes an interface housing 1505 and may be similar to previously described interface housings. The speed control interface 1500 includes an interface portion 1510. In some examples, the interface portion 1510 includes a plurality of indicators 1515 configured to indicate the present speed selection from among the plurality of speed settings of the power tool 100. As a user increases or decreases a speed setting of the power tool 100, the corresponding speed selection is represented by the plurality of indicators 1515. In some embodiments, the plurality of indicators 1515 is a strip of light emitting diodes (LEDs). In some embodiments, the plurality of indicators 1515 is an LED strip, a light bar, or any other type of illuminating indicator. An individual one of the plurality of indicators 1515 can be illuminated to illustrate a selected speed setting. Alternatively, multiple of the indicators 1515 can be illuminated to illustrate a selected speed setting (e.g., three out of five indicators illuminated to show the third highest of five speed settings). In some embodiments, the interface portion 1510 can also be used in conjunction with any of the speed selection inputs described herein. In some embodiments, the speed selection comes from a remote or external device (e.g., a mobile phone). In some embodiments, the speed control interface 1500 is implemented on the same printed circuit board as the controller 202 or is electrically connected to the printed circuit board that includes the controller 202.

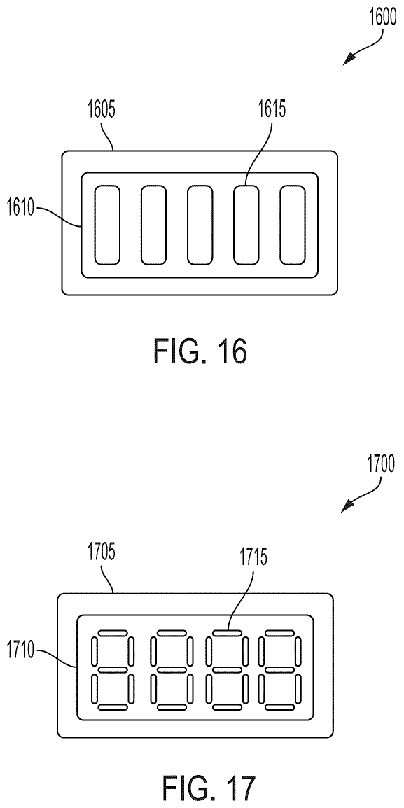

FIG. 16 illustrates a speed control interface 1600 for the power tool 100, according to some embodiments. The speed control interface 1600 includes an interface housing 1605 and may be similar to previously described interface housings. The speed control interface 1600 includes an interface portion 1610. The interface portion 1610 includes a plurality of indicators 1615 configured to indicate the present speed selection from among the plurality of speed settings of the power tool 100. In the illustrated embodiment, the plurality of indicators 1615 is an LED bar. As a user increases or decreases a speed setting of the power tool 100, the corresponding speed selection is represented by the plurality of indicators 1615. An individual one of the plurality of indicators 1615 can be illuminated to illustrate a selected speed setting. Alternatively, multiple of the indicators 1615 can be illuminated to illustrate a selected speed setting (e.g., three out of five indicators illuminated to show the third highest of five speed settings). In some embodiments, the interface portion 1610 can also be used in conjunction with any of the speed selection inputs described herein. In some embodiments, the speed selection comes from a remote or external device (e.g., a mobile phone). In some embodiments, the speed control interface 1600 is implemented on the same printed circuit board as the controller 202 or is electrically connected to the printed circuit board that includes the controller 202.

FIG. 17 illustrates a speed control interface 1700 for a power tool, according to some embodiments. The speed control interface 1700 includes an interface housing 1705 and may be similar to previously described interface housings. The speed control interface 1700 includes an interface portion 1710. The interface portion 1710 includes a plurality of indicators 1715 configured to indicate the present speed selection from among the plurality of speed settings of the power tool 100. In the illustrated embodiment, the plurality of indicators 1715 include a plurality of a seven-segment displays. As a user increases or decreases a speed setting of the power tool 100, the corresponding speed selection is represented by the seven-segment displays. The plurality of indicators 1715 may indicate other information, such as a motor speed, a torque setting, or an error code associated with a tool error. In some embodiments, the speed control interface 1700 is implemented on the same printed circuit board as the controller 202 or is electrically connected to the printed circuit board that includes the controller 202.

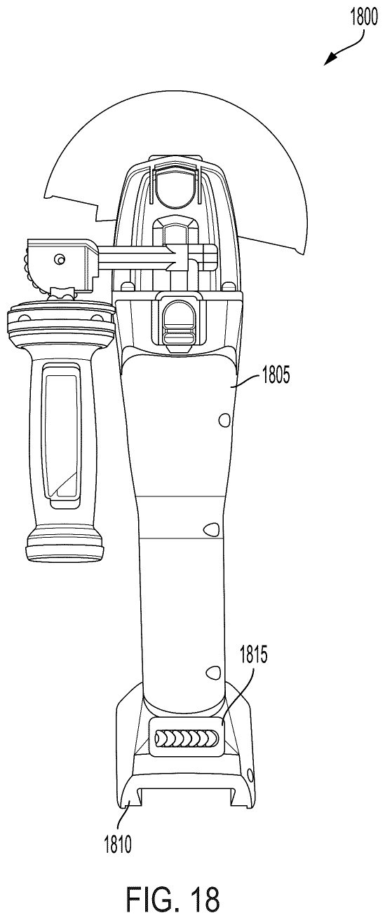

FIG. 18 illustrates a power tool 1800 including a speed control interface, according to some embodiments. In some embodiments, the power tool 1800 is a grinder. The power tool 1800 includes some common elements of previously described power tool 100. For example, the power tool 1800 includes a housing 1805, a battery pack interface 1810, and a speed control interface 1815. In some embodiments, the speed control interface 1815 is the capacitive touch interface, such as speed control interface 600, speed control interface 800, or speed control interface 900. The speed control interface 1815 is positioned at the second user interface portion 115 of the power tool 100. In other embodiments, the speed control interface 1815 is positioned at the first user interface portion 110 or another location of the power tool 100.

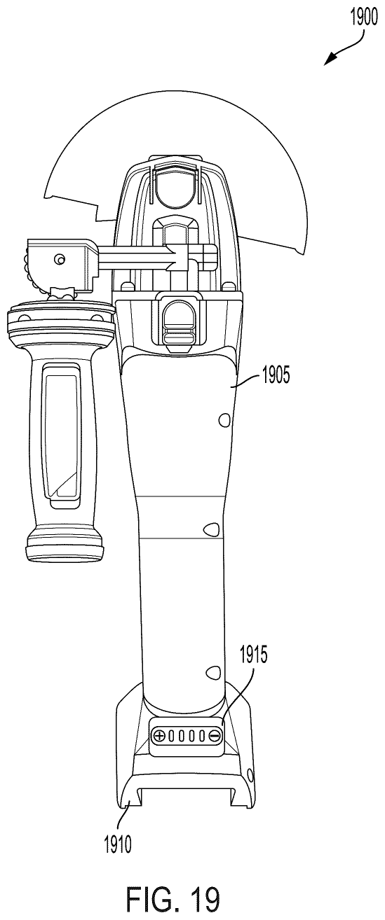

FIG. 19 illustrates a power tool 1900 including a speed control interface, according to some embodiments. In some embodiments, the power tool 1900 is a grinder. The power tool 1900 includes some common elements of previously described power tool 100. For example, the power tool 1900 includes a housing 1905, a battery pack interface 1910, and a speed control interface 1915. In some embodiments, the speed control interface 1915 includes both indicators and increase/decrease inputs, such as speed control interface 600 or speed control interface 1100. The speed control interface 1915 is positioned at the second user interface portion 115 of the power tool 100. In other embodiments, the speed control interface 1915 is positioned at the first user interface portion 110 or another location of the power tool 100.

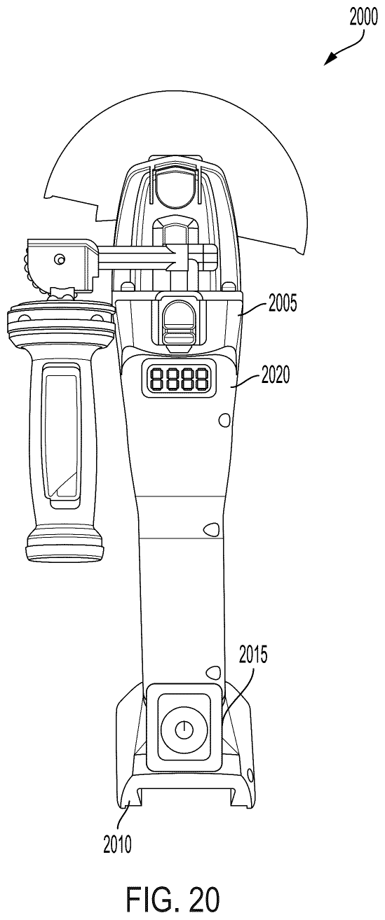

FIG. 20 illustrates a power tool 2000 including a speed control interface, according to some embodiments. In some embodiments, the power tool 2000 is a grinder. The power tool 2000 includes some common elements of previously described power tool 100. For example, the power tool 2000 includes a housing 2005, a battery pack interface 2010, and a speed control interface 2015. In some embodiments, the speed control interface 2015 includes an inductive wheel, such as speed control interface 1000. The speed control interface 2015 is positioned at the second user interface portion 115 of the power tool 100. In other embodiments, the speed control interface 1915 is positioned at the first user interface portion 110 or another location of the power tool 100. In the illustrated embodiment, the speed control interface 2015 include a second speed control interface or display 2020 positioned at the first user interface portion 110 of the power tool 100. The second speed control interface is, for example, the speed control interface 1700 including a plurality of seven-segment displays.

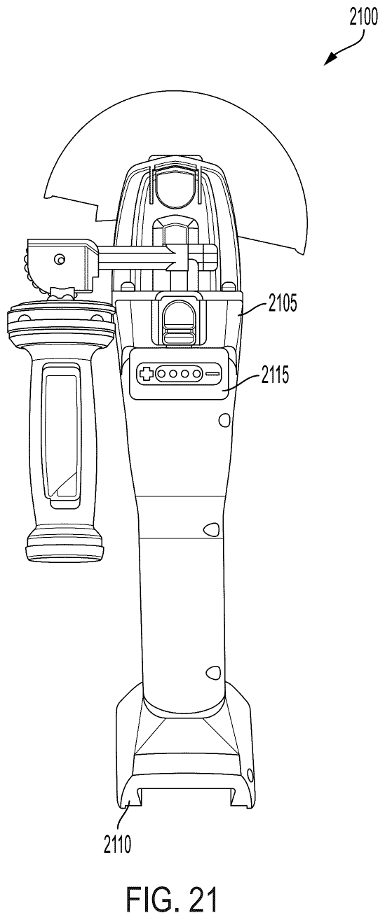

FIG. 21 illustrates a power tool 2100 including a speed control interface, according to some embodiments. In some embodiments, the power tool 2100 is a grinder. The power tool 2100 includes some common elements of previously described power tool 100. For example, the power tool 2100 includes a housing 2105, a battery pack interface 2110, and a speed control interface 2115. In some embodiments, the speed control interface 2115 includes both indicators and increase/decrease inputs, such as speed control interface 600 or speed control interface 1100. The speed control interface 2115 is positioned at the first user interface portion 110 of the power tool 100.

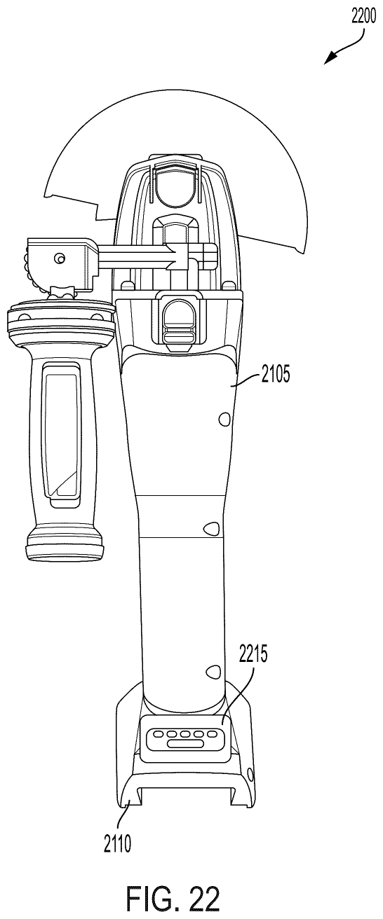

FIG. 22 illustrates a power tool 2200 including a speed control interface, according to some embodiments. In some embodiments, the power tool 2200 is a grinder. The power tool 2200 includes some common elements of previously described power tool 100. For example, the power tool 2200 includes a housing 2205, a battery pack interface 2210, and a speed control interface 2215. In some embodiments, the speed control interface 2215 includes both indicators and an increase or decrease input, such as speed control interface 1200. The speed control interface 2215 is positioned at the second user interface portion 115 of the power tool 100. In other embodiments, the speed control interface 1915 is positioned at the first user interface portion 110 or another location of the power tool 100.

The power tools of FIGS. 18-22 are shown for illustrative purposes. Any combinations of speed control interfaces described herein can be used in a power tool and, for example, be positioned at the first user interface portion 110 and/or the second user interface portion 115 of the power tool 100.

Thus, embodiments described herein provide a power tool including speed setting interface for controlling a speed setting of the power tool. Various features and advantages are set forth in the following claims.

What is claimed is:

1. A power tool comprising:
a housing;
a battery pack interface positioned at an end of the housing, the battery pack interface configured to receive a removable and rechargeable battery pack;
a user input configured to control driving of a motor when actuated by a user;
a speed control interface including a first interface portion and a second interface portion, the first interface portion including a capacitive touch surface configured to generate a speed setting signal in response to detecting a touch of the user, the second interface portion including a display that includes a plurality of indicators configured to indicate a speed setting of the power tool; and
a controller including a memory and an electronic processor, the controller configured to:
receive the speed setting signal, and
control, in response to an actuation of the user input, the motor to the speed setting.

2. The power tool of claim 1, wherein the first interface portion includes a speed increase selector and a speed decrease selector.

3. The power tool of claim 1, where in the capacitive touch surface is configured to receive one or more multi-touch gestures.

4. The power tool of claim 1, wherein the plurality of indicators includes one or more light emitting diodes.

5. The power tool of claim 1, wherein the plurality of indicators includes an E-ink display.

6. The power tool of claim 1, wherein the plurality of indicators are further configured to display an error code associated with a tool error.

7. The power tool of claim 1, wherein the capacitive touch surface includes a capacitive touch slider configured to detect a sliding touch of the user,
where, in response to detecting the sliding touch of the user in a first direction, the capacitive touch surface is configured to generate a speed increase setting signal, and
where, in response to detecting the sliding touch of the user in a second direction, the capacitive touch surface is configured to generate a speed decrease setting signal.

8. The power tool of claim 1, wherein the speed setting of the power tool includes a plurality of speed settings, and the first interface portion includes a plurality of capacitive touch surfaces,
wherein each of the plurality of capacitive touch surfaces includes a capacitive touch input element, and
wherein each of the plurality of capacitive touch input elements of the plurality of capacitive touch surfaces corresponds to one of the plurality of speed settings.

9. A power tool comprising:
a housing;
a battery pack interface positioned at an end of the housing, the battery pack interface configured to receive a removable and rechargeable battery pack;
a user input configured to control driving of a motor when actuated by a user;
a speed control interface configured to generate a speed setting signal including a speed setting from among a plurality of speed settings, the speed control interface including a speed increase selector configured to increase a speed selection of the speed setting from among the plurality of speed settings, a speed decrease selector configured to decrease the speed selection of the speed setting from among the plurality of speed settings, and
a plurality of indicators configured to indicate the speed setting selected from among the plurality of speed settings; and
a controller including a memory and an electronic processor, the controller configured to:
receive the speed setting signal, and
control, in response to an actuation of the user input, the motor to the speed setting.

10. The power tool of claim 9, wherein the speed increase selector and the speed decrease selector each include a touch sensitive surface.

11. The power tool of claim 9, wherein the plurality of indicators include one or more light emitting diodes.

12. The power tool of claim 9, wherein the plurality of indicators include an E-ink display.

13. The power tool of claim 9, wherein the plurality of indicators are further configured to display an error code associated with a tool error.

14. A speed control system for a power tool, the speed control system comprising:
a speed control interface configured to generate a speed setting signal including a speed setting from among a plurality of speed settings, the speed control interface configured to increase a speed selection of the speed setting from among the plurality of speed settings and decrease the speed selection of the speed setting from among the plurality of speed settings; and
a plurality of indicators configured to indicate the speed setting selected from among the plurality of speed settings; and
a circuit board including a memory and an electronic processor, the electronic processor configured to:
receive the speed setting signal including the speed setting from among the plurality of speed settings, and
control, in response to an actuation of a user input, a motor of the power tool to the speed setting.

15. The speed control system of claim 14, wherein the plurality of indicators include one or more light emitting diodes.

16. The speed control system of claim 14, wherein the plurality of indicators include an E-ink display.

17. The speed control system of claim 14, wherein the plurality of indicators are further configured to display an error code associated with a tool error.

18. The speed control system of claim 14, wherein:
the speed control interface includes a speed increase selector and a speed decrease selector;
the speed increase selector includes a first capacitive touch element configured to detect a sliding touch of a user;
the speed decrease selector includes a second capacitive touch element configured to detect the sliding touch of the user,
in response to detecting the sliding touch of the user in a first direction, the speed increase selector is configured to generate a speed increase setting signal, and
in response to detecting the sliding touch of the user in a second direction, the speed decrease selector is configured to generate a speed decrease setting signal.

19. The speed control system of claim 18, wherein the speed increase selector and the speed decrease selector are mechanical buttons.

20. The speed control system of claim 14, wherein:
the speed control interface includes an inductive sensor configured to detect a touch of a user in a first direction and the touch of the user in a second direction;
the electronic processor is configured to increase the speed selection of the speed setting from among the plurality of speed settings in response to the inductive sensor detecting the touch of the user in the first direction; and
the electronic processor is configured to decrease the speed selection of the speed setting from among the plurality of speed settings in response to the inductive sensor detecting the touch of the user in the second direction.
